(19) United States
(12) Patent Application Publication
(10) Pub. No.: US 2022/0284503 A1
(43) Pub. Date: Sep. 8, 2022

(54) Beauty and Health Supplies Delivery System

(71) Applicant: Craig Faison, Hiram, GA (US)

(72) Inventor: Craig Faison, Hiram, GA (US)

(21) Appl. No.: 17/510,811

(22) Filed: Oct. 26, 2021

Related U.S. Application Data
(60) Provisional application No. 63/156,609, filed on Mar. 4, 2021.

(51) Int. Cl. G06Q 30/06; G06Q 10/08; G06Q 50/30

(52) U.S. Cl. CPC G06Q 30/0639; G06Q 10/087; G06Q 10/0833; G06Q 30/0635; G06Q 30/0641; G06Q 50/30

(57) ABSTRACT

The present invention relates generally to a beauty supply delivery system primarily comprised of a software/mobile application that allows a user to place an order for beauty and/or health supplies. The order is then delivered via a delivery driver in a same-day time frame or shortly thereafter. The software/mobile application further contains a portal for suppliers of products sold on the system and a portal for delivery drivers. In addition, the system has a messaging feature and map interface to allow a user to locate and communicate with the delivery driver in real-time.

### CROSS-REFERENCE TO RELATED APPLICATION

The present application claims priority to, and the benefit of, U.S. Provisional Application No. 63/156,609 which was filed on Mar. 4, 2021 and is incorporated herein by reference in its entirety.

### FIELD OF THE INVENTION

The present invention relates generally to the field of delivery applications. More specifically, the present invention relates to a beauty supply delivery system primarily comprised of a software/mobile application that allows a user to place an order for beauty and/or health supplies. The order is then delivered via a delivery driver in a same-day time frame or shortly thereafter. Accordingly, the present disclosure makes specific reference thereto. Nonetheless, it is to be appreciated that aspects of the present invention are also equally applicable to other like applications, systems and methods of manufacture.

### BACKGROUND

Many cosmetic and hair professionals require various beauty and health-related supplies to perform their job. However, ordering and obtaining beauty and health-related supplies can be stressful and difficult, especially when individuals may not be able to order the supplies from reputable suppliers. Even when reputable suppliers have been identified, individuals often cannot obtain the supplies ordered in a prompt time frame, such as same day, one day or even several day delivery, unless the supplier's physical location is in close proximity to the individual. However, even if a supplier is located close to an individual, the individual may not be able to travel to the supplier to pick up the order based on his or her personal/work schedule, as well as a lack of mobility or vehicle access. All of the aforementioned problems are undesirable. Further, if a cosmetic or hair professional cannot readily obtain beauty or health supplies, he or she may not be able to efficiently and effectively run the business and/or perform the job.

Therefore, there exists a long-felt need in the art for an improved system for delivery of beauty supplies. There also exists a long-felt need in the art for a beauty supplies delivery system that allows a user to easily order beauty supplies from a reputable supply. Further, there exists a long-felt need in the art for a beauty supply delivery system that allows a user to easily order beauty supplies from a reputable supplier, wherein the system does not require that a user pick up the order, and instead allows the order to be delivered to the user. In addition, there exists a long-felt need in the art for a beauty supply delivery system, that allows a user to easily order beauty supplies from a reputable supplier, and wherein the system quickly delivers the order to a user.

The subject matter disclosed and claimed herein, in one embodiment thereof, comprises a beauty supply delivery system. The system is primarily comprised of a software/mobile application that allows a user to place an order for beauty and/or health-related supplies. The order is then delivered via a delivery driver in a same-day time frame or shortly thereafter. The software/mobile application further contains a portal for suppliers of products sold on the system and a portal for delivery drivers. In addition, the system has a messaging feature and map interface to allow a user to locate and communicate with the delivery driver in real-time.

In this manner, the beauty supply delivery system of the present invention accomplishes all of the forgoing objectives and provides an improved delivery system for beauty and/or health-related supplies. The system allows a user to easily and quickly order beauty and/or health supplies from a reputable supplier. However, the system does not require that a user pick up the order, and instead allows the order to be delivered to the user. In this manner, the beauty supplies delivery system allows a user to acquire beauty and health products and/or supplies in a manner and process not currently available.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a beauty supply delivery system. The system is primarily comprised of a software application that allows users to easily and conveniently place and receive orders for supplies, goods and products related to beauty and health. The software application may be a mobile application that can be used on a smart device and/or a computer-based software application or website. The application further has a supplier portal that allows potential suppliers of health/beauty products to apply for their products to be available for purchase on the system. Using the portal, a potential supplier inputs relevant business information, such as but not limited to, tax returns, income statements, product reviews, product lists/inventory, types of products carried, brands carried, inventory prices, hours of operation, etc. As a result, administrators of the system can ensure any supplier within the system is reputable and worthy of doing business. Further, each supplier may have his or her own profile page that displays information, such as but not limited to, business hours, locations, products offered, current inventory, contact information, etc.

The system allows users to place orders for health and beauty-related supplies/products. Each product is further organized within the system via a plurality of categories that include but are not limited to: type of product (i.e., hair product, skin product, etc.), product use, product brand, product price, product color, product ingredients, product material, product name, etc. As a result, a user can sort all products by their desired category. In addition, the system has a search engine that allows a user to search for a specific product by name or keywords. Before placing an order, a user creates a profile that includes information such as, but not limited to, name, business name, address, payment information (i.e., credit card numbers, etc.), products interested in, etc. After completing the profile, a user can then sign in to place an order. The system further allows a user to select specific order criteria such as, without limitation, the delivery location of the order, the delivery time of the order, and the method of payment (i.e., credit card, debit card, cryptocurrency, payment installments, etc.).

The system also has a portal for delivery drivers, that deliver the order of the user. The portal is further comprised of a profile page that allows a driver to input information such as, but not limited to, delivery availability, geographical location, vehicle make/model/VIN, license plate number, license number, background check information, etc. The profile page further assigns each driver a unique driver identification number, wherein an artificial intelligence and/or algorithm, then automatically assigns each order to a delivery driver. In addition, the system may have a bidding interface that allows drivers to bid against one another to obtain deliveries. It should be appreciated that the system preferably allows an order to be delivered within the same day as when it was placed by a user. However, in order to ensure same day delivery, the order must be placed within the hours of operation of each supplier provided on the profile page of the supplier. In an event that a user wishes to place an order outside of the hours of operation of a supplier, the system further prompts a user with an estimated time of delivery for when the order will be delivered.

Accordingly, the beauty supply delivery system of the present invention is particularly advantageous, as it allows a user to easily and quickly order beauty and/or health supplies from a reputable supplier. However, the system does not require that a user pick up their order, and instead allows the order to be delivered. In this manner, the beauty supply delivery system allows a user to otherwise acquire beauty and health supplies in a manner not currently available.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of the primary components of one potential embodiment of the beauty supply delivery system of the present invention in accordance with the disclosed architecture;

FIG. 2 illustrates a graphical view of the delivery driver's primary components of one potential embodiment of the beauty supply delivery system of the present invention in accordance with the disclosed architecture; and

FIG. 3 illustrates a graphical view of the primary components associated with orders for one potential embodiment of the beauty supply delivery system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and systems are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved system for delivering beauty and/or health related supplies. There also exists a long-felt need in the art for a beauty supply delivery system that allows a user to easily order beauty and/or health-related supplies from a reputable supplier and that does not require a user to pick up the order, but instead allows the order to be delivered to the user. In addition, there exists a long-felt need in the art for a beauty supply delivery system that allows a user to easily order beauty and/or health supplies from a reputable supplier, wherein the system quickly delivers supplies to the user.

The present invention, in one exemplary embodiment, is comprised of a beauty and health supply delivery system primarily comprised of a software application that allows users to easily and conveniently place and receive orders for supplies/goods related to beauty and health. The software application may be a mobile application that can be used on a smart device and/or a computer-based software application or website. Further, the software application has a supplier portal that allows potential suppliers of health/beauty products to apply for their products to be available for purchase on the system. Using the portal, a potential supplier inputs relevant business information, such as but not limited to: tax returns, income statements, product reviews, product lists/inventory, types of products carried, brands carried, inventory prices, hours of operation, etc. As a result, administrators of the system can ensure any supplier within the system is reputable and worthy of doing business. Further, each supplier may also have their own profile page that displays information, such as but not limited to: business hours, locations, products offered, current inventory, contact information, etc.

Using the system, users can place orders for health and beauty-related supplies/products. Within the system, each product is further organized via a plurality of categories such as, but not limited to, type of product (i.e., hair product, skin product, etc.), product use, product brand, product price, product color, product ingredients, product material, product name, etc. As a result, a user can sort all products by a desired category. In addition, the system has a search engine that allows a user to search for a specific product by name or keywords. Before placing an order, a user creates a profile that includes information, such as but not limited to: name, business name, address, payment information (i.e., credit card numbers, etc.), products interested in, etc. After completing the profile, a user can then sign in to place an order. The system further allows a user to select specific order criteria when placing the order, such as but not limited to: the delivery location of the order, the delivery time of the order and the method of payment (i.e., credit card, debit card, cryptocurrency, payment installments, etc.).

The system also has a portal for delivery drivers that deliver the order of the user, wherein the portal is further comprised of a profile page that allows a driver to input information such as, but not limited to, delivery availability, geographical location, vehicle make/model/VIN, license plate number, license number, background check information, etc. The profile page further assigns each driver a unique driver identification number, wherein an artificial intelligence and/or algorithm then automatically assigns each order to a delivery driver. The system may also have a bidding interface that allows drivers to bid against one another to obtain deliveries. It should be appreciated that the system preferably allows an order to be delivered within the same day as it was placed by a user. However, in order to ensure same day delivery, the order must be placed within the hours of operation of each supplier provided on the profile page of the supplier. In an event that a user wishes to place an order outside of the hours of operation of a supplier, the system further prompts a user with an estimated time of delivery of when the order will be delivered.

Accordingly, the beauty supplies delivery system of the present invention is particularly advantageous, as it allows a user to easily and quickly order beauty and/or health supplies from a reputable supplier and does not require that a user physically pick up their order from said supplier. Instead, the system allows the order to be delivered. In this manner, the beauty supplies delivery system allows a user to otherwise acquire beauty and health products in a manner not currently available.

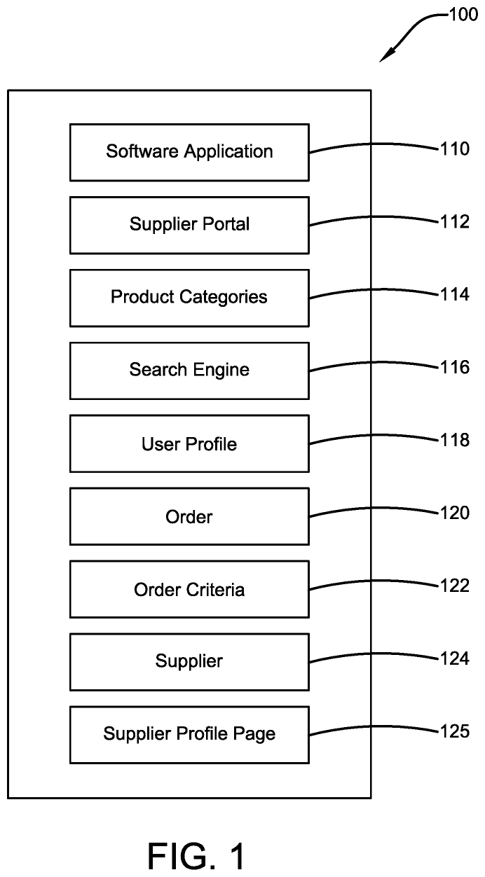

Referring initially to the drawings, FIG. 1 illustrates a graphical view of the primary components of one embodiment of the beauty supply delivery system 100 of the present invention. The system 100 is primarily comprised of a software application 110 that allows users to easily and conveniently place and receive orders 120 for supplies, goods, products, etc., related to beauty and health. In differing embodiments, the software application 110 may be in the form of a mobile application that can be used on a smart device and/or a computer-based software application or website. The application 110 further has a supplier portal 112 that allows potential suppliers of health/beauty products listed on the system 100 to apply for their products to be available for purchase on the system 100. Using the portal 112, a potential supplier 124 inputs relevant business information, such as but not limited to: tax returns, income statements, product reviews, product lists/inventory, types of products carried, brands carried, inventory prices, hours of operation, etc. In this manner, administrators of the system 100 can ensure any supplier 124 within the system is reputable and worthy of doing business with users. Further, each supplier 124 may have their own profile page 125, wherein the profile page 125 displays information, such as but not limited to: business hours, locations, products offered, current inventory, contact information, etc.

It should be appreciated that the system 100 allows users to place orders for a plurality of beauty and/or health related supplies, goods, products, etc. Said products and supplies can include but are not limited to: beauty tools, health tools, hair products, skin products, makeup products, body washing products, fragrances, oral hygiene products, nails products, immune system products, wearable beauty accessories, body health-related products (i.e., medications, organic medicines, etc.), or any other suitable beauty/health products known in the art. Each product is further organized within the system via a plurality of categories 114. Said categories 114 can include but are not limited to: type of product (i.e., hair product, skin product, etc.), product use, product brand, product price, product color, product ingredients, product material, product name, etc. As a result, a user can sort all products by a desired category 114. In addition, the system 100 has a search engine 116, that allows a user to search for a specific product by name or keywords.

Before placing an order 120, a user creates a profile 118. The profile 118 includes information such as, but not limited to, name, business name, address, payment information (i.e., credit card numbers, etc.), products interested in, etc. After completing the profile 118, a user can then sign in to place an order 120. It is contemplated that in differing embodiments, a user can use the system 100 to make bulk or individual orders 120 for any number of health or beauty supplies, goods, products, etc. The system 100 further allows a user to select specific order criteria 122. Said criteria 122 includes but is not limited to: the delivery location of the order, the delivery time of the order and the method of payment (i.e., credit card, debit card, cryptocurrency, payment installments, etc.). Once an order 120 has been placed, the contents of the order 120 is sent to a supplier 124.

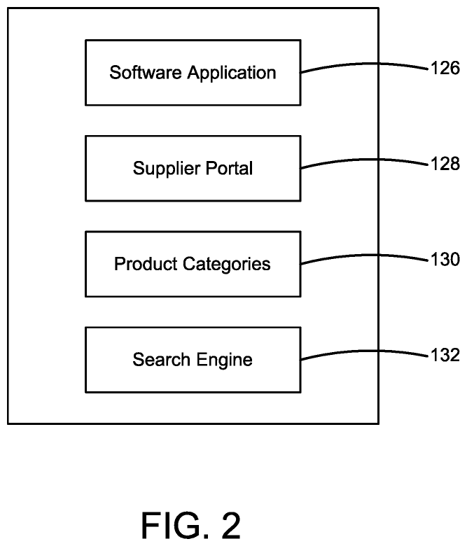

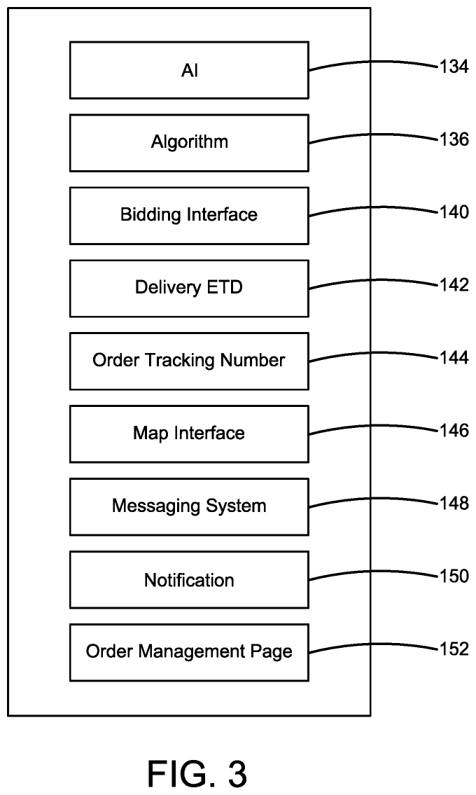

FIG. 2 illustrates a graphical view of the primary components of the delivery drivers of the beauty supplies delivery system 100 of the present invention. The system 100 is further comprised of a portal 126 for delivery drivers 130 that deliver the order 120 to the user. The portal 126 is further comprised of a profile page 128 that allows a driver 130 to input information such as, but not limited to, delivery availability, geographical location, vehicle make/model/VIN, license plate number, license number, background check information, etc. The profile page 128 further assigns each driver 130 a unique driver identification number 132. The system 100 also has an artificial intelligence 134 and/or algorithm 136 (shown in FIG. 3) that automatically assigns each order 120 to a delivery driver 130. When assigning an order 120 to a driver 130, the artificial intelligence 134 and/or algorithm 136 considers factors, such as but not limited to, number of current deliveries of the driver 130, location of current deliveries of the driver 130, etc. In addition, the system 100 may have a bidding interface 140 that allows drivers 130 to bid against one another to obtain deliveries. Using the interface 140, each driver 130 can bid a dollar amount he or she is willing to accept as payment for delivery of the order 120. It should be appreciated that the system 100 preferably allows an order 120 to be delivered within the same day as it was placed by a user. However, in order to ensure same day delivery, the order 120 must be placed within the hours of operation of each supplier 124 provided on the profile page 118 of the supplier. In the event that a user wishes to place an order 120 outside of the hours of operation of a supplier 124, the system 100 further prompts a user with an estimated time of delivery 142 of when the order will be delivered.

FIG. 3 illustrates a graphical view of the primary components of an order for the beauty supply delivery system 100 of the present invention. In order to allow a user to track his or her orders 120, the system 100 may further assign a unique tracking number 144 to each order 120. In addition, the system 100 may have a map interface 146 that allows a user to see the real-time location of the delivery driver 126 that is delivering the order 120. Further, the system 100 may have a messaging system 148 that allows for a user to call, text or email a delivery driver 130 about the status of the order 120. The system 100 may also provide a call, text or email notification 150 informing a user of an order confirmation and the estimated delivery time of the order 120. An order management page 152 further allows a user to view existing or past orders 120. In addition, the page 152 allows a user to add new orders, manage/edit/cancel existing orders, and set up recurring orders, such that specific orders of specific products can be delivered on a daily, weekly, monthly, yearly or other customized delivery frequency.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “beauty supplies delivery system”, “beauty and health supplies delivery system” and “system” are interchangeable and refer to the beauty supply delivery system 100 of the present invention.

Notwithstanding the forgoing, the beauty supply delivery system 100 of the present invention and its various components can be of any suitable size and configuration as is known in the art without affecting the overall concept of the invention, provided that they accomplish the above-stated objectives. One of ordinary skill in the art will appreciate that the size, configuration and material of the beauty supply delivery system 100 as shown in FIGS. 1-3 is for illustrative purposes only, and that many other sizes and shapes of the beauty supply delivery system 100 are well within the scope of the present disclosure. Although the dimensions of the beauty supply delivery system 100 are important design parameters for user convenience, the beauty supply delivery system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A beauty supplies delivery system comprising:
a software application that allows a user to place and receive orders for health and beauty supplies;
a supplier portal that allows suppliers of health and beauty products to list their products on the supplier portal;
a user profile that a user creates before placing an order;
a driver profile page for managing drivers; and
an order management page for managing user orders, wherein the user orders are delivered by a delivery driver within a predetermined time frame.

2. The beauty supplies delivery system of claim 1, wherein the software application is configured in form of a mobile application that can be used on a smart device.

3. The beauty supplies delivery system of claim 1, wherein the software application is configured as a computer-based software application or website.

4. The beauty supplies delivery system of claim 1, wherein in order for suppliers to list their health and beauty products on the supplier portal, the suppliers must input information such as tax returns, income statements, product reviews, product lists/inventory, types of products carried, brands carried, inventory prices, and hours of operation.

5. The beauty supplies delivery system of claim 4, wherein each supplier comprises a profile page which displays business hours, locations, products offered, current inventory, and contact information.

6. The beauty supplies delivery system of claim 1, wherein each product is organized within the supplier portal via a plurality of categories, such as type of product, product use, product brand, product price, product color, product ingredients, product material, and product name.

7. The beauty supplies delivery system of claim 6, wherein the supplier portal comprises a search engine, that allows a user to search for a specific product by name or keywords.

8. The beauty supplies delivery system of claim 1, wherein the user profile comprises information such as name, business name, address, payment information, and products interested in.

9. A beauty supplies delivery system comprising:
a software application that allows a user to place and receive orders for health and beauty supplies;
a supplier portal that allows suppliers of health and beauty products to list their products on the supplier portal;
a user profile that a user creates before placing an order;
an order management page for managing user orders, wherein the order management page allows a user to call, text, or email a delivery driver about a status of their order, and further wherein the user orders are delivered by a delivery driver within a predetermined time frame; and
a messaging system that provides a call, text, or email notification informing a user of an order confirmation and an estimated delivery time of the order.

10. The beauty supplies delivery system of claim 9, wherein the order management page allows a user to view existing or past orders, and allows a user to add new orders, manage existing orders, and set up recurring orders.

11. The beauty supplies delivery system of claim 9, wherein the order can be delivered within same day the order was made, if ordered within hours of operation of the supplier.

12. The beauty supplies delivery system of claim 11, wherein if the user places an order outside of the hours of operation of the supplier, a user will be prompted with an estimated time of delivery of when the order will be delivered.

13. A beauty supplies delivery system comprising:
a software application that allows a user to place and receive orders for health and beauty supplies;
a supplier portal that allows suppliers of health and beauty products to list their products on the supplier portal;
a search engine that allows a user to search for a specific product listed on the supplier portal;
a user profile that a user creates before placing an order;
a delivery driver portal which uses a map interface for tracking a delivery driver;
an order management page for managing user orders, wherein the order management page allows a user to view existing or past orders, add new orders, manage existing orders, and set up recurring orders, and further wherein the user orders are delivered by a delivery driver within a predetermined time frame; and
a messaging system that provides a call, text, or email notification informing a user of an order confirmation and an estimated delivery time of the order.

14. The beauty supplies delivery system of claim 13, wherein the delivery driver portal comprises a profile page that allows a delivery driver to input information such as a delivery availability, a geographical location, a vehicle make/model/VIN, a license plate number, a license number, and a background check information.

15. The beauty supplies delivery system of claim 14, wherein the delivery driver profile page further assigns a delivery driver a unique driver identification number.

16. The beauty supplies delivery system of claim 15, wherein artificial intelligence or an algorithm automatically assigns an order to a delivery driver.

17. The beauty supplies delivery system of claim 16, wherein in order to allow a user to track an order, the beauty supplies delivery system assigns a unique tracking number to the order.

18. The beauty supplies delivery system of claim 17, wherein the map interface allows a user to see a real-time location of a delivery driver that is delivering an order.

19. The beauty supplies delivery system of claim 18, further comprising a bidding interface that allows a delivery driver to bid against other delivery drivers to obtain a delivery of an order.

20. The beauty supplies delivery system of claim 19, wherein the messaging system allows a user to call, text, or email a delivery driver about a status of their order.
